(19) United States
(12) Patent Application Publication
(10) Pub. No.: US 2023/0216762 A1
(43) Pub. Date: Jul. 6, 2023

(54) MACHINE LEARNING TO MONITOR NETWORK CONNECTIVITY

(71) Applicant: ResMed Digital Health Inc., San Diego, CA (US)

(72) Inventors: Amir Nasser SHAMDANI, San Diego, CA (US); Jinzhao FENG, San Diego, CA (US)

(21) Appl. No.: 18/086,280

(22) Filed: Dec. 21, 2022

Related U.S. Application Data
(60) Provisional application No. 63/295,775, filed on Dec. 31, 2021.

(51) Int. Cl. H04L 43/0811; H04L 41/16

(52) U.S. Cl. CPC H04L 43/0811; H04L 41/16; G06N 20/00

(57) ABSTRACT

Techniques for monitoring network connectivity using machine learning are provided. A plurality of historical connectivity records is received, and a first machine learning model type, of a plurality of machine learning model types, is selected based on the plurality of historical connectivity records. A machine learning model, of the first machine learning model type, is trained based on the plurality of historical connectivity records, where the machine learning model learns to generate forecasted connectivity records based on the training.

### CROSS-REFERENCE TO RELATED APPLICATIONS

This application claims priority to U.S. Provisional Patent Application No. 63/295,775, filed Dec. 31, 2022, the entire content of which is incorporated herein by reference in its entirety.

### INTRODUCTION

Aspects of the present disclosure relate to machine learning. More specifically, aspects of the present disclosure relate to using machine learning to monitor network connectivity.

Network connectivity has recently become an increasingly important part of the ordinary operations of a wide variety of devices. These connected devices can be deployed in any number and variation of environments, and have been used for a virtually unlimited variety of tasks. In many cases, connected devices can include traditional devices (such as smartphones and computers) as well as Internet of Things (IoT) devices, where traditionally non-networked objects are configured for network connectivity. For example, in the case of smart home systems, objects such as thermostats, lights, blinds, and the like have been designed to utilize network connectivity to enable automated and/or remote control of the environment.

In many instances, these connected devices can additionally or alternatively use their network connectivity to provide various data or pings (such as status updates) to other devices or systems (such as centralized applications or repositories). For example, some connected devices are configured to regularly transmit status updates and other data to a central application, indicating various metrics such as the use time of the device, operating state, any repair or damage concerns, the software version being used, the hardware being used, and the like. This can allow the central system to monitor a wide swath of deployed devices.

However, when network connectivity problems arise in one or more regions or technologies, these connected devices are often unable to reach the central system. Further, the centralized system, which relies on these updates, may fail to operate effectively. As such, monitoring network connectivity can be crucial. However, in conventional systems, the wide variety of deployed devices, communication technologies, and geographic distributions prevent realistic network monitoring, and can allow connectivity concerns to remain undetected (and unaddressed) for significant periods of time.

Improved systems and techniques to monitor network connectivity are needed.

### SUMMARY

According to one embodiment presented in this disclosure, a method is provided that includes: receiving a first plurality of historical connectivity records; selecting a first machine learning model type, of a plurality of machine learning model types, based on the first plurality of historical connectivity records; and training a first machine learning model, of the first machine learning model type, based on the first plurality of historical connectivity records, wherein the first machine learning model learns to generate forecasted connectivity records based on the training.

According to a second embodiment of the present disclosure, a computer program product is provided that comprises logic encoded in a non-transitory medium, the logic executable by operation of one or more computer processors to perform an operation comprising: receiving a plurality of current connectivity records; identifying a first machine learning model, of a plurality of machine learning models, based on the plurality of current connectivity records; and generating forecasted connectivity records by processing the plurality of current connectivity records using the first machine learning model.

Other aspects provide processing systems configured to perform the aforementioned method as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### DESCRIPTION OF THE DRAWINGS

The appended figures depict certain aspects of the one or more embodiments and are therefore not to be considered limiting of the scope of this disclosure.

FIG. 1 depicts an example environment to use machine learning to analyze network connectivity data.

FIG. 2 depicts an example workflow for training machine learning models to predict network connectivity.

FIG. 3 depicts an example workflow for using machine learning to monitor network connectivity data and to initiate various actions based on connectivity determinations.

FIG. 4 is a flow diagram depicting an example method of training machine learning models to monitor network connectivity status.

FIG. 5 is a flow diagram depicting an example method of using machine learning models to monitor network connectivity status.

FIG. 6 is a flow diagram depicting an example method of training a machine learning model based on historical network connectivity data.

FIG. 7 is a flow diagram depicting an example method of generating forecasted network connectivity using a trained machine learning model.

FIG. 8 depicts an example computing device configured to perform various aspects of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for improved network connectivity monitoring using machine learning models.

In some embodiments, an analysis system is configured to train machine learning models based on historic device connectivity, and/or to use trained machine learning models to predict future device connectivity. Although some aspects of the present disclosure describe a single analysis system as performing both training and inferencing, in some embodiments, separate systems may be used for each operation. For example, a first system may train and/or refine the machine learning models, which may then be deployed for use by a second system to predict future connectivity.

In at least one embodiment, the analysis system applies machine learning to massive amounts of data (which may include streaming telemetry data generated by various applications and devices, as well as data relating to various telecom provider infrastructures). In an embodiment, the analysis system can surface the relevant metrics and use them to identify connectivity issues, accelerate root cause analysis, and reduce mean time to repair.

In at least one embodiment, the analysis system evaluates connectivity data in the form of connection records (also referred to as dial-in records) from connected devices. In one such embodiment, a variety of devices may be configured to regularly transmit status updates or other information (e.g., whenever the device is activated, deactivated, or changes state, or on a periodic schedule such as once a day) to a centralized application or repository. For example, continuous positive airway pressure (CPAP) machines may be configured such that, whenever the device is deactivated and/or the mask is removed from the user's face, the CPAP machine transmits one or more records to the central system indicating, for example, what time the device was activated the night before, what time it was deactivated, various metrics of the overnight use (e.g., the number of breathing events, such as due to brief wake-ups or short-term drops in blood oxygen levels), and the like.

Although CPAP machines and other medical devices are used in some examples discussed herein, in embodiments, any device capable of providing data or pings can be used. In some embodiments, the actual data being transmitted by each device need not be known by the analysis system. That is, when evaluating network connectivity, the analysis system need not know the contents of the transmission (e.g., how many breathing events were detected). Instead, the analysis system need only know whether connectivity was available at the dial-in time (which is inherently indicated by the mere receipt of the dial-in). Accordingly, in some embodiments, the analysis system can operate on aggregated and anonymized data indicating when transmission(s) were received from each device.

In an embodiment, the analysis system can train one or more machine learning models, based on a set of historical connection records, to predict future connectivity. In some embodiments, the analysis system trains or refines the machine learning model periodically to adapt to dynamic and potentially-changing dial-in patterns. For example, in one such embodiment, the analysis system can re-train a model (which may include refining an existing model, or training an entirely new model) each night, based on historical data from the last N days (where N is a hyperparameter defined by a user or administrator). The model can then be used to predict the next day's connectivity patterns, and incoming traffic can be compared with these predicted values to detect any anomalies at a granular level.

In some embodiments, the analysis system can train and use multiple machine learning models, depending on the desired granularity of analysis. That is, given one or more sets of device or communication characteristics, the analysis system may train a separate machine learning model for each such set of characteristics. For example, a first set of characteristics may correspond to one or more specific device types, one or more specific software packages being used by the devices, and the like. By training a model for this particular set of devices, the analysis system can readily identify connectivity problems specific to these devices (e.g., due to faulty software or hardware). As a further example, a second set of characteristics may correspond to a given set of geographic region(s) (e.g., a country, county, state, or locale). As still another example, the set of characteristics may specify a given network or communication technology or technologies (e.g., CDMA, 2G, 3G, 4G, 5G, and the like). As yet another example, the set of characteristics may define a given set of telecom provider(s). By training models for each such sets, the analysis system can identify connectivity problems with respect to the relevant region(s), technologies, and/or telecom providers.

In at least one embodiment, the particular model architecture used for each set of devices or communication records may be selected based, at least in part, on the number of connection records that exist in the set. For example, when the average number of connections (e.g., per day) having the desired characteristics exceeds some threshold, an autoregressive integrated moving average (ARIMA) model type may be used. Generally, ARIMA models are well-adapted for time series analysis and data forecasting, but they generally require significant amounts of training data to operate effectively.

As used herein, an ARIMA model may be a generalization of an autoregressive moving average (ARMA) model, where both these models can be exploited for forecasting the future points in the time series. The “autoregressive” part of ARIMA indicates that the evolving variable of interest is regressed on its own prior values. The “moving average” part may indicate that the regression error is a linear combination of error terms whose values occurred contemporaneously and at various times in the past. In some aspects, the “integrated” portion indicates that the data values may have been replaced with the difference between their values and the previous values, while this differencing process may have been performed more than once.

In some embodiments, the analysis system may use other (less complex) models, such as a Gaussian unbiased parameter estimator, if the ARIMA architecture fails to converge. As used herein, an estimator may be a rule or model for calculating an estimate of a given quantity based on observed data. For example, the sample mean is a commonly used estimator. The bias of an estimator may refer to the difference between the estimator's expected value and the true value of the parameter being estimated. Generally, for observations based on a distribution, the bias is the mean of the difference between the estimated value and the observed value. If, for all values of the distribution, the bias is zero, the estimator may be referred to as an unbiased estimator. A Gaussian distribution is a type of continuous probability distribution for a real-valued random variable.

In some embodiments, if the number of connections is below some threshold, the analysis system may use other architectures, such as linear regression, to prevent over-fitting that can be caused by ARIMA models when little data is available. A linear regression is generally a linear approach for modeling the relationship between a scalar response and one or more explanatory variables (also known as dependent and independent variables). In linear regression, the relationships can be modeled using linear predictor functions whose unknown model parameters are estimated from the data.

In one embodiment, if the number of connections is below a lower threshold, the analysis system may rely on other architectures, such as median estimators, to provide more accurate predictions for the limited data samples. The mean is known as the expected value of the distribution. On the other hand, the median is the value separating the higher half from the lower half of a data sample, a population, or a probability distribution. The basic feature of the median in describing data compared to the mean (often simply described as the “average”) is that it is not skewed by a small proportion of extremely large or small values, and therefore may provide a better representation of a “typical” value.

Example Environment for Machine Learning to Monitor Network Connectivity

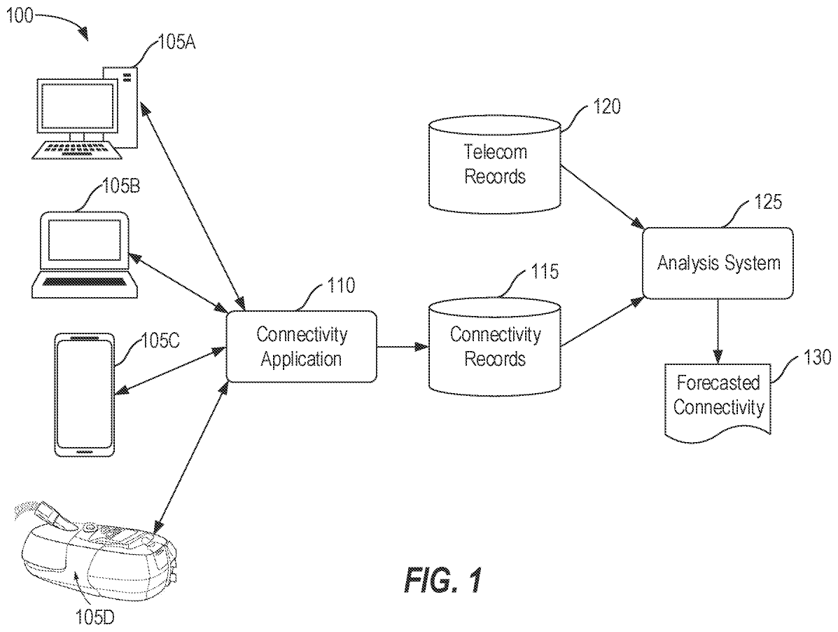

FIG. 1 depicts an example environment 100 to use machine learning to analyze network connectivity data.

In the illustrated example, the environment 100 includes a set of connected devices 105A-D (collectively connected devices 105). Although four devices are included for illustrative purposes, there may of course be any number of connected devices 105 in the environment 100. Generally, each connected device 105 corresponds to some computing device that has network connectivity and is configured to, at least occasionally (e.g., periodically or upon specified events) transmit some data (which may be a simple ping or “still alive” message). Generally, the connected devices 105 can be communicatively coupled to the network via any means, including wired links and/or wireless links. Similarly, the connected devices 105 may use any suitable communications technologies, protocols, providers, and the like. Additionally, the connected devices 105 may be distributed across any number and variety of geographic locales, including in different counties, regions, states, or countries.

In the illustrated example, the connected devices 105 can include a wide variety of computing devices, including a desktop computer (indicated by 105A), a laptop computer (indicated by 105B), a smartphone (indicated by 105C), and a medical device, such as a CPAP machine (indicated by 105D). As illustrated, each connected device 105 may be communicatively coupled with a connectivity application 110. In embodiments, this link may be provided via a direct connection, or through one or more networks (which may, in some aspects, include the Internet).

Additionally, though depicted as two-way communication links, in some aspects, one or more of the links may be unidirectional (e.g., enabling a connected device 105 to transmit data to the connectivity application 110). Generally, as discussed above, the connected devices 105 are configured to send some communication to the connectivity application 110 at various times and under various conditions (e.g., whenever the device is activated or deactivated). Although a single connectivity application 110 is depicted for conceptual clarity, in embodiments, there may be multiple applications or systems that receive the transmissions from the connected devices 105.

As illustrated, the transmissions received by the connectivity application are used to generate or define a set of connectivity records 115. Generally, each connectivity record 115 corresponds to a transmission or communication from a connected device 105. The connectivity records 115 can generally indicate a variety of characteristics of the underlying transmission, such as the specific identity of the connected device 105, the type of connected device 105, what hardware and/or software the connected device 105 uses, the time of the transmission, and the like. Notably, in at least one embodiment, the connectivity records 115 do not include the actual content of the transmission. For example, if connected device 105D transmits details relating to how well the user slept (e.g., the number of breaths per hour, pulse rate, and the like), the connectivity application 110 may strip this content and provide only an indication that the device transmitted a message at the specific time.

In some embodiments, the connectivity records can further include information relating to the method of communication used by the connected device (e.g., what network technology was used). In other embodiments, these communication characteristics can be provided in other sources such as telecom records 120. For example, the telecom records 120 may indicate, for each connected device 105 (e.g., identified based on a subscriber identifier of each device), the technology used, the telecom provider or carrier, country where the transmission was initiated, the locality or region (e.g., based on the cell tower that received it), and the like.

As illustrated, an analysis system 125 can receive and evaluate the telecom records 120 and the connectivity records 115 to generate forecasted connectivity 130. In some embodiments, the analysis system 125 receives the connectivity records 115 (representing dial-in data), and correlates it with telecom records 120 to enable more granular and comprehensive analysis. For example, the connectivity records 115 may enable the analysis system 125 to monitor connectivity with respect to individual software packages of each connected device 105, and the telecom records 120 may enable monitoring on the basis of geographic location, telecom provider, and the like. In this way, the analysis system 125 can specifically pinpoint any connectivity issues (e.g., specifically identifying particular telecom provider in a particular region) to enable rapid remediation, as well as to prevent errors in any analysis that relies on the incoming data.

In an embodiment, the analysis system 125 uses one or more machine learning models to generate the forecasted connectivity 130. In at least one embodiment, as discussed above, the analysis system 125 can train a respective machine learning model for each desired subset of the connected devices 105 (e.g., for each set of connection characteristics that the analysis system 125 monitors). For example, a user may specify that the analysis system 125 should monitor connectivity with respect to a given region, telecom provider, type of device, or combinations of the same, and the like. When a new connectivity record 115 is received, the analysis system 125 can retrieve the corresponding model, and use it to generate forecasted connectivity 130.

The forecasted connectivity 130 generally indicates one or more predicted future connection events. In some embodiments, the analysis system 125 generates forecasted connectivity 130 using a window of current (or immediately prior) connectivity records 115. For, example, given a set of connectivity records 115 received over the last thirty minutes, the analysis system 125 can predict connectivity for the next thirty minutes. In embodiments, the particular window size may differ depending on a variety of factors, including user configuration, the average number of connectivity records 115 received (for the subset of devices), and the like.

Additionally, in some embodiments, the analysis system 125 can compare a previously-generated forecasted connectivity 130 with the currently-received connectivity records. That is, during an initial window at T₀, the analysis system 125 can use the connectivity records R₀ to generate forecasted connectivity F₁, for the next window of time. During the next adjacent window of time T₁, the analysis system 125 can use the received records R₁ to generate forecasted connectivity F₂ for the subsequent window. Additionally, the analysis system 125 may compare the received records R₁ that actually belong in the window T₁ (e.g., indicated by timestamps) with the forecasted records F₁ for the window. This can allow the analysis system 125 to rapidly detect any potential connectivity issues occurring during the window T₁.

In at least one aspect, the analysis system 125 can use one or more thresholds to determine whether the currently-received connectivity records 115 (e.g., R₁) are within a defined range or percentile from the forecasted connectivity (e.g., F₁). For example, the analysis system 125 may determine whether the number of received connectivity records 115 for the window is within one or more standard deviations of the forecast, or within a percentile (e.g., within 50% of a lower boundary, which may itself be defined using standard deviations, mean, variance, percentiles, and the like).

In some aspects, the analysis system 125 evaluates the current records to determine whether the number of records received (or otherwise belonging to) the window is below this threshold. For example, if the currently-received connectivity records 115 for a window of time are below this threshold, the analysis system 125 may determine or infer that connectivity issues are occurring for the given set of devices (e.g., due to software glitches, telecom outages, and the like).

In at least one embodiment, the analysis system 125 can additionally or alternatively evaluate the records to determine whether they exceed some threshold above the forecasted connectivity 130. For example, if an unexpectedly larger number of connectivity records 115 are received during the window, the analysis system 125 may determine or infer that other disruptions may be occurring in the given region (e.g., a natural disaster, causing a larger number of people to use their devices at an otherwise unusual time).

In embodiments, the analysis system 125 can initiate a variety of actions based on the comparison between the actual connectivity and the forecasted connectivity 130. In at least one embodiment, the analysis system 125 can generate and/or transmit an alert indicating the potential disruption. In some embodiments, the analysis system 125 may transmit an alert to one or more users who request to be alerted for the given set of devices. For example, suppose a healthcare provider interacts with the connectivity application 110 to receive updates on a variety of patients using connected devices 105. In one embodiment, if the analysis system 125 determines that there is a connectivity problem with respect to the relevant set of connected devices 105 (or some subset thereof), the analysis system 125 may transmit an alert to the healthcare provider. In some embodiments, the analysis system 125 can transmit the alert to one or more entities that may be able to remediate the issue. For example, if the analysis system 125 determines that the issue lies with a particular telecom provider, the analysis system 125 may alert this provider.

In some embodiments, the analysis system 125 can take other proactive actions. Continuing the above example (with a healthcare provider that relies on the data provided to the connectivity application 110), suppose the healthcare provider calls or otherwise contacts the operator of the connectivity application 110 to inquire as to why the data they received appears to be anomalous. In one embodiment, the system can determine that the caller or requestor may be affected by the detected connectivity concerns (e.g., based on the identity of the requestor, the origin location of the call, and the like), and return an automated message indicating the potential disruptions. This can significantly reduce the manual effort that conventional systems require to notify and respond to affected users.

In some embodiments, when training the machine learning models, the analysis system 125 can consider extrinsic factors (outside of the specific characteristics of the connected devices 105 and/or connection links). For example, in one embodiment, the analysis system 125 can train distinct models for work days (e.g., Monday through Friday) and non-work days (e.g., Saturday, Sunday, and holidays). That is, if a user wishes to monitor connectivity for a particular region, the analysis system 125 may automatically train a first model to monitor work day traffic for the region, while a second is trained to monitor non-work day traffic. This can allow for more accurate predictions.

In at least one embodiment, the analysis system 125 can identify and exclude outlier data when training the models. For example, if the analysis system 125 trains the model using the past thirty days of connectivity data (or the last thirty work days, as discussed above), the analysis system 125 may evaluate the data on each respective day to ensure that the connectivity from that day is not an outlier (e.g., because there were an unusually high or an unusually low number of connections for that day). In various embodiments, this outlier determination may be made using a variety of criteria, such as determining whether the number of connections from that respective day exceed a defined threshold value or percentage above or below the average number over the thirty-day window (or whatever window the analysis system 125 uses), or determining whether the connections are distributed sufficiently differently during the day, as compared to the average (e.g., with more connections later in the day, rather than in the morning).

If the data for a given day is an outlier, in one embodiment, the analysis system 125 can discard this data and select data from another day to train the model. For example, if the analysis system 125 ordinarily uses data from the past twenty non-work days, and one of those day is determined to be anomalous, the analysis system 125 may discard the outlier data and use data from the non-work day that is twenty-one days prior.

Example Workflow for Training Machine Learning Models to Monitor Network Connectivity

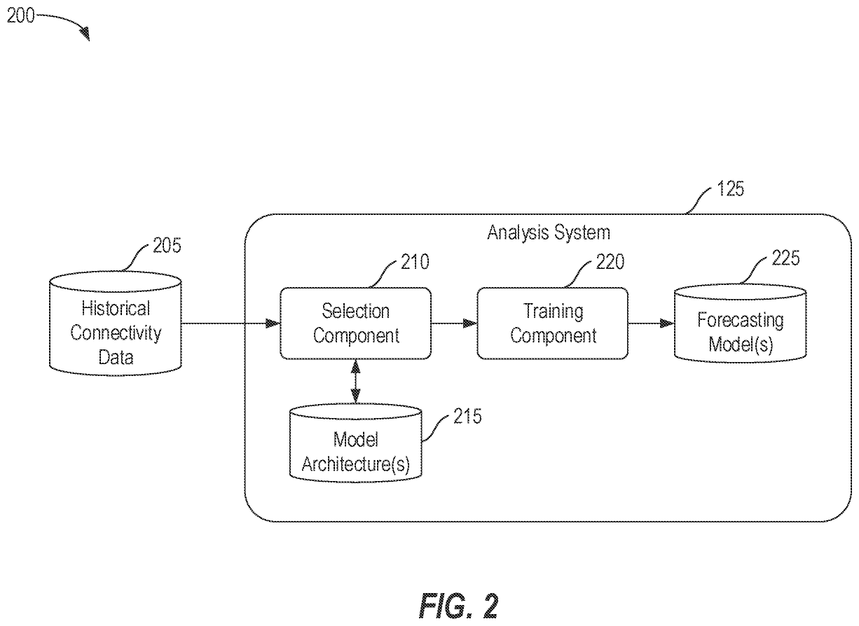

FIG. 2 depicts an example workflow 200 for training machine learning models to predict network connectivity. In some embodiments, the workflow 200 is performed by an analysis system (e.g., analysis system 125 of FIG. 1).

In the illustrated example, the analysis system 125 includes a selection component 210 and training component 220, as well as repositories for model architectures 215 and forecasting models 225. Although depicted as discrete components for conceptual clarity, in embodiments, the operations and functionality of the selection component 210 and training component 220 may be combined or distributed across any number of components and devices. Additionally, although depicted as residing within the analysis system 125, in embodiments, the model architectures 215 and/or forecasting models 225 may reside in any suitable location. Further, although the illustrated workflow 200 depicts historical connectivity data 205 as residing externally to the analysis system 125, in some embodiments, this data is stored within the analysis system 125.

As illustrated, the historical connectivity data 205 is provided to the selection component 210. Generally, the historical connectivity data 205 includes prior connectivity records (and, in some embodiments, corresponding telecom records) for connections (e.g., from connected devices 105 of FIG. 1). For example, the historical connectivity data 205 may include records of connections or transmissions that were received during one or more prior days (or are associated with timestamps from one or more prior days). In an embodiment, if the analysis system 125 trains (or retrains) models periodically, such as overnight, the historical connectivity data 205 may include records received that day.

In some embodiments, the historical connectivity data 205 includes only records with the desired characteristics for a machine learning model. For example, the historical connectivity data 205 may correspond to transmissions received from a particular geographic region. In other embodiments, the historical connectivity data 205 can include other records, and the selection component 210 can identify and select the relevant record(s) for each desired set of characteristics/connections (e.g., filtering the historical connectivity data 205 based on region, telecom provider, and the like).

In an embodiment, the selection component 210 evaluates the historical connectivity data 205 to select an appropriate model architecture 215. As discussed above, in at least one embodiment, the selection component 210 selects a model architecture 215 based on the number of connectivity records that are included in the relevant subset (e.g., the average number of connections per day). For example, the selection component 210 may use one or more threshold values, and select the best model architecture 215 based on the average number of records in the set.

As one example, the selection component 210 may select an ARIMA model architecture where there is a relatively high traffic load, such that any errors can be corrected by using a complex model. For example, if the average number of connections per day is greater than ten thousand, the selection component 210 may select an ARIMA model. In some embodiments, in addition to selecting a model architecture 215, the selection component 210 can also define other hyperparameters for the model, such as the downsample window (e.g., the window of time over which records are evaluated). For example, if there are greater than one hundred thousand connections per day, the selection component 210 may select an ARIMA model with a five minute window (indicating that, during inferencing and training, the model will evaluate data corresponding to a five minute window in order to generate predictions for the subsequent five minute window). As another example, if there are greater than ten thousand connections per day (but less than one hundred thousand), the selection component 210 may use an ARIMA model with a thirty minute downsample window. These thresholds are merely included as examples, and any suitable thresholds or parameters can be used in various embodiments.

In some embodiments, if the analysis system 125 determines that the ARIMA model has failed to converge on a given set of training data (e.g., data from a particular set of connected devices), the selection component 210 can select another model, such as a Gaussian unbiased parameter estimator, for this set of data. In some cases, the ARIMA model may be incompatible or otherwise sub-optimal for certain time series data, but it may be difficult or impossible to tell a priori whether a given set of data will work. In an embodiment, therefore, the training does not converge, the system can return to model selection and train another (relatively less complex) model for the data.

In some embodiments, if the average number of connections is below the minimum threshold for a highly complex model (such as an ARIMA model), the selection component 210 may select another model that is less susceptible to overfitting, such as a linear regression model. In at least one embodiment, if the selection component 210 selects a linear regression model, the selection component 210 also sets the downsample window to cover an entire day. That is, the model may be trained to predict future connectivity for the entire day, rather than in five or thirty minute windows.

If the average number of connections is below another minimum threshold for this less-complex model (e.g., below a minimum threshold for linear regression to operate effectively), in some embodiments, the selection component 210 selects another model that is more readily able to handle high volatility and noise in small samples, such as a median estimator. For example, if the average number of connections in the set is less than one thousand per day, the median estimator may operate effectively while a linear regression model may fail to perform accurately. In some embodiments, when a median estimator is selected, the selection component 210 can also use a downsample window covering the entire day.

In some embodiments, as discussed above, the downsample window defines fixed and non-overlapping windows. In other embodiments, the windows may be partially overlapping. In at least one embodiment, the downsample window is a sliding window. Generally, by referring to a defined set of rules and thresholds, the selection component 210 can select the best model architecture 215, downsample window, and any other relevant hyperparameters for a given set of data (e.g., for data corresponding to each desired geographic region).

As one example, Table 1 below depicts a variety of model architectures, reasons why one may be selected for a given set of connectivity records, the context of use, the downsample window size, and the confidence interval of each (e.g., the thresholds used to determine whether new data is anomalous or outside of the predicted range). Of course, the values and thresholds given in Table 1 are merely examples, and the particular parameters used may vary depending on the particular deployment and implementation.

TABLE 1

| Model | Reason(s) | Context | Downsample | Confidence |
|---|---|---|---|---|
| Architecture | for Use | of Use | Window | Interval |
| ARIMA | High load | Average | Five | Mean +/− |
| | traffic, error | dial-ins | minutes, | 5*Sigma |
| | can be | greater | no overlap | |
| | corrected | than one | | |
| | using | hundred | | |
| | complex | thousand | | |
| | model | per day | | |
| | | Average | Thirty | Mean +/− |
| | | dial-ins | minutes, | 5*Sigma |
| | | greater | no overlap | |
| | | than ten | | |
| | | thousand | | |
| | | per day | | |
| Gaussian | ARIMA | Fallback | N/A | Mean +/− |
| Unbiased | may be | method | | 5*Sigma |
| Parameter | incompatible | when | | |
| Estimator | with some | ARIMA | | |
| | time series | training | | |
| | data | fails to | | |
| | | converge | | |
| Linear | ARIMA can | Average | Whole day, | Mean +/− |
| Regression | overfit, | dial-ins | no overlap | 5*Sigma |
| | but the | greater | | |
| | trend may | than one | | |
| | remain clear | thousand | | |
| | | per day | | |
| Median | High | Average | Whole day, | Median +/− |
| Estimator | volatility; | dial-ins | no overlap | 0.5*Median |
| | noise | greater | | |
| | dominates | than twenty | | |
| | true values | per day | | |

In the illustrated workflow 200, once the selection component 210 selects a model architecture 215, the training component 220 uses the (relevant subset of) historical connectivity data 205 to train a machine learning model using the selected model architecture 215. Generally, how the model is trained may vary depending on the particular architecture selected. For example, if an ARIMA model is selected, the training component 220 may use backpropagation to refine the model parameters. In at least one embodiment, training the model includes processing data from a given window, using the model, to generate predicted connectivity (e.g., a predicted number of connections) in a subsequent window. This prediction can then be compared against the actual number of connections in this subsequent window (e.g., the average number of connections during the window over the last N days), and the difference can be used to compute a loss to refine the model (such as via backpropagation).

Once the training component 220 completes training the selected model architecture 215 for the given set of data records, the model can be stored as a forecasting model 225 for use in predicting future connectivity. For example, in at least one embodiment, the analysis system 125 trains the forecasting model(s) 225 overnight, and deploys these newly-trained models for use in forecasting connectivity for the next day. In an embodiment, if multiple models are to be trained (e.g., if the analysis system 125 is configured to monitor connectivity for multiple different locales, levels of granularity, and the like), the workflow 200 can be repeated (sequentially or in parallel) to select and train an appropriate model for each set of connectivity data.

In some embodiments, as discussed above, the forecasting models 225 are subsequently used by the analysis system 125 to predict future connectivity during runtime. In other embodiments, the analysis system 125 may deploy the forecasting models 225 to one or more other devices, which use them to generate the predicted connectivity during runtime.

Example Workflow for Use of Machine Learning Models to Monitor Network Connectivity

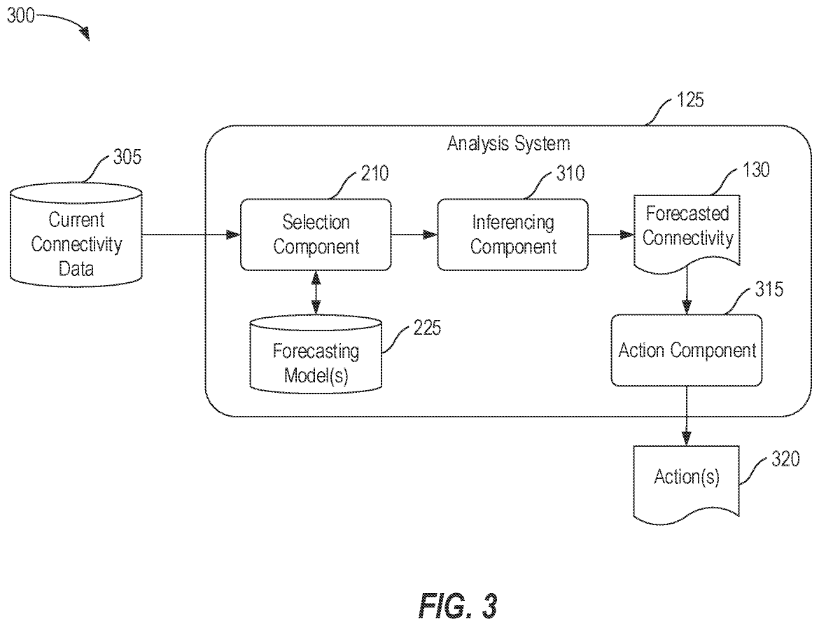

FIG. 3 depicts an example workflow 300 for using trained machine learning models to monitor network connectivity data and initiate various actions based on the connectivity. In some embodiments, the workflow 300 is performed by an analysis system (e.g., analysis system 125 of FIG. 1).

In the illustrated workflow 300, the analysis system 125 includes a selection component 210, an inferencing component 310, and an action component 315, as well as repositories for pre-trained forecasting models 225 (e.g., trained using the workflow 200 of FIG. 2). Although depicted as discrete components for conceptual clarity, in embodiments, the operations and functionality of the selection component 210, inferencing component 310, and action component 315 may be combined or distributed across any number of components and devices. Additionally, although depicted as residing within the analysis system 125, in embodiments, the forecasting models 225 may reside in any suitable location. Further, although the illustrated workflow 200 depicts current connectivity data 305 as residing externally to the analysis system 125, in some embodiments, this data is stored within the analysis system 125.

As illustrated, the current connectivity data 305 is provided to the selection component 210. Generally, the current connectivity data 305 includes connectivity records (and, in some embodiments, corresponding telecom records) for data connections (e.g., from connected devices 105 of FIG. 1) received for processing during runtime. For example, the current connectivity data 305 may include records of connections or transmissions that were received during one or more prior windows of time (e.g., over the last thirty minutes).

In some embodiments, the current connectivity data 305 includes only records with the desired characteristics to be monitored. For example, the current connectivity data 305 may correspond to transmissions received from a particular geographic region. In other embodiments, the current connectivity data 305 can include other records, and the selection component 210 can identify and select the relevant record(s) for each desired set of characteristics/connections (e.g., filtering the current connectivity data 305 based on region, telecom provider, and the like).

In an embodiment, the selection component 210 evaluates the current connectivity data 305 to select an appropriate forecasting model 225. For example, as discussed above, in at least one embodiment, forecasting models 225 have each been trained for a particular set of connection characteristics (e.g., for connections from particular device types, in particular areas, using particular networking technologies, and the like). Therefore, in the illustrated workflow 300, the selection component 210 can evaluate each (set of) newly-received current connectivity data 305, and retrieve the corresponding forecasting model 225 that was trained for the specific set of characteristics reflected in the set of data.

As illustrated, the inferencing component 310 can then process some or all of the current connectivity data 305 using the selected forecasting model 225 to generate forecasted connectivity 130. In at least one embodiment, as discussed above, the inferencing component 310 can generate forecasted connectivity 130 for one or more future windows of time (e.g., defined by the indicated downsample window), based on current connectivity data 305 from one or more current or immediately prior windows of time. For example, based on current connectivity data 305 for the past thirty minutes, the inferencing component 310 may generate forecasted connectivity 130 for the next thirty minutes.

In some embodiments, the forecasted connectivity 130 indicates the number of connections that are predicted to occur during the relevant future window, where a connection may be considered to have “occurred” during the window if it is received during the window, and/or if it has a timestamp within the window. In some embodiments, in addition to or instead of predicting the number of connections, the forecasted connectivity 130 can indicate other connection characteristics.

As illustrated, the forecasted connectivity 130 can then be evaluated by the action component 315. As discussed above, in some embodiments, the action component 315 compares the forecasted connectivity 130 with current data from the next window. That is, for window Tₙ, the action component 315 may compare forecasted data F_{n.} (generated based on current data from the prior window Tₙ₋₁) with the actual current data Rₙ received during window Tₙ. This can allow the analysis system 125 to use the current connectivity data 305 for a given window to not only generate forecasted connectivity 130 for the next window, but also to selectively trigger alerts or other actions 320 for the current window.

In an embodiment, as discussed above, the action component 315 can determine whether to trigger one or more actions 320 based on whether the forecasted connectivity 130 for a given window and the actual current connectivity data 305 for the window differ by more than a defined threshold. For example, if the number of records in the current connectivity data 305 differs by more than 25% of the forecasted connectivity 130, the action component 315 may determine that the current data is anomalous and trigger one or more actions 320.

In embodiments, as discussed above, the particular actions 320 may vary, and can include actions such as transmitting an alert to one or more entities (e.g., entities that might be able to fix the problem, entities that are expecting incoming data, users of the connected devices 105, and the like). The alert my indicate, for example, the number of affected devices, characteristics of the affected devices, the affected regions, the affected telecom providers, the affected network technologies, and the like (depending on the particular characteristics for which the model was trained). Other example actions 320 may include detecting and re-routing (or automatically responding to) inquiries from affected entities or users, initiating one or more remedial actions to correct the connectivity issue (e.g., causing the connected devices 105 to use alternative network technologies, if possible), and the like.

In some embodiments, as discussed above, the forecasting models 225 are used by the same analysis system 125 that trained them (e.g., using the workflow 200). In other embodiments, the analysis system 125 that uses the trained forecasting models 225 may differ from the system that trained them.

Example Method for Training Machine Learning Models to Monitor Network Connectivity

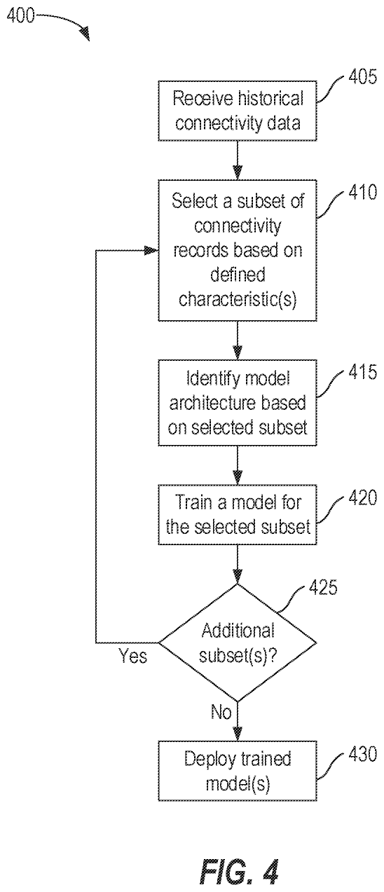

FIG. 4 is a flow diagram depicting an example method 400 of training machine learning models to monitor network connectivity status. In some embodiments, the method 400 is performed by an analysis system, such as analysis system 125 of FIG. 1.

At block 405, the analysis system receives a set of historical connectivity data (e.g., historical connectivity data 205 of FIG. 2). As discussed above, the historical connectivity data can generally correspond to prior transmissions or connections from connected devices, and the historical connectivity data can be used to train or refine one or more machine learning models. In an embodiment, the historical connectivity data includes a set of records, each corresponding to a given transmission, dial-in, or connection from a connected device, and each specifying relevant characteristics of the connection (e.g., identifying the type of device, the software package being executed by the device, the time of the connection, and the like). In some embodiments, the historical connectivity data is augmented with one or more attributes or characteristics of the communication link or network used to transmit the connection, such as the telecom provider, network technology, and the like.

At block 410, the analysis system selects a subset of the records in the historical connectivity data, based on a defined set of characteristics for which a model is to be trained (e.g., as specified by a user). For example, the analysis system may select a set of records that were all transmitted from a given geographic region, using a given telecom provider, using a given network technology, and the like. This can allow the analysis system to train a model to specifically monitor the particular network connectivity. In some embodiments, as discussed above, the analysis system can further select the subset to include only work days, or only non-work days, in order to train a corresponding model.

At block 415, the analysis system identifies the optimal model architecture for the selected subset. For example, as discussed above, the analysis system may determine the average number of records per day in the selected subset (e.g., over the last thirty days), and select a model architecture (e.g., an ARIMA model) based on a set of defined rules and thresholds. In some embodiments, selecting the model architecture also includes defining one or more hyperparameters (such as the downsample window, the number of prior days to be included, and the like) based on the rules or other user configuration.

At block 420, the analysis system trains a model having the selected architecture based on the selected subset of connectivity records, as discussed above. Generally, as a result of the training, the model learns to predict future connectivity (e.g., to predict the number of connections that will occur during a future downsample window) by processing received records for one or more prior windows.

At block 425, the analysis system determines whether there is at least one additional subset of characteristics for which a model is to be trained. For example, as discussed above, a user may indicate which subset(s) of devices, regions, telecom providers, network technologies, or other attributes they wish to monitor. The analysis system can then train a model for each indicated subset.

In some embodiments, the subsets of characteristics may be partially overlapping. For example, the analysis system may train a first model for a given state (using connectivity records from that state), and train a second model for a country that includes that state. Similarly, the analysis system may train an overall model for a given country, and train separate models for each network technology used in the country.

If one or more additional subsets remain, the method 400 returns to block 410, where the analysis system selects another subset for training. If no additional subsets remain, the method 400 continues to block 430.

At block 430, the analysis system deploys the trained model(s) for inferencing. As discussed above, in some embodiments, the analysis system can itself use the models for inferencing during runtime. In some embodiments, deploying the models includes deploying them to one or more other devices, systems, or components for use during runtime.

In embodiments, as discussed above, these trained models can be used to predict network connectivity at future times, enabling the network(s) to be monitored in real-time (as actual data is received and compared against the predictions). By rapidly identifying technological network issues that prevent connectivity, the analysis system is able to quickly facilitate remediation (e.g., by providing granular and timely alerts to telecom providers or other entities responsible for the faulty link or node).

Additionally, the analysis system is able to prevent faulty analysis or improper actions from being taken by other entities based on the (missing) underlying data. For example, as discussed above, a central application or system may depend on data from the connected devices in order to perform a variety of tasks and analyses. If this flow of data is affected by one or more outages (e.g., such that some subset of the connected devices can no longer transmit updates), the central system can easily make erroneous conclusions or initiate flawed actions, operating on faulty data. Moreover, the partial data can lead to wasted computational resources (e.g., storage, processing time, and energy used to evaluate the partial data). However, as the analysis system enables rapid identification of these connectivity faults, the techniques described herein can prevent these invalid analyses, wasted computational expense, and potentially harmful actions from ever being taken. This can significantly improve the technological environment and the functioning of the computing devices and systems themselves.

Example Method for Use of Machine Learning Models to Monitor Network Connectivity

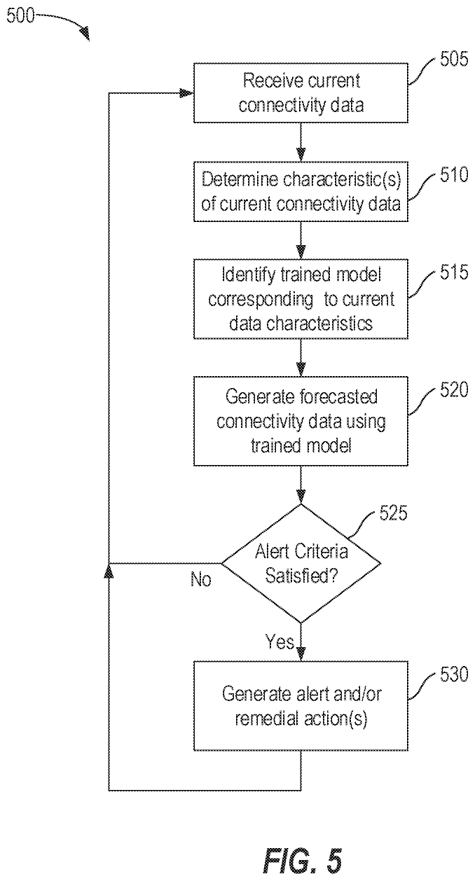

FIG. 5 is a flow diagram depicting an example method 500 of using machine learning models to monitor network connectivity status (e.g., by using machine learning to predict future connectivity). In some embodiments, the method 500 is performed by an analysis system (e.g., analysis system 125 of FIG. 1).

At block 505, the analysis system receives current connectivity data (e.g., current connectivity data 305 of FIG. 3). As discussed above, the current connectivity data can generally correspond to transmissions or connections from connected devices that were received for inferencing (e.g., during the current day). In an embodiment, the current connectivity data includes a set of records, each corresponding to a given transmission, dial-in, or connection from a connected device, and each specifying relevant characteristics of the connection (e.g., identifying the type of device, the software package being executed by the device, the time of the connection, and the like). In some embodiments, the current connectivity data is augmented with one or more attributes or characteristics of the communication link or network used to transmit the connection, such as the telecom provider, network technology, and the like.

At block 510, the analysis system determines the characteristics of the received connectivity data in order to determine which model(s) should be used to process the data. For example, depending on the particular subsets or models that have been trained, the analysis system can determine, for each record, the geographic area, telecom provider, type of device, network technology, and the like.

At block 515, the analysis system identifies the machine learning model that was trained for the data characteristics of the currently-received record(s). For example, as discussed above, the analysis system may use various architectures such as an ARIMA model, a Gaussian unbiased estimator, a linear regression model, a median estimator, and the like, depending on the characteristics of the underlying data.

The method 500 then continues to block 520, where the analysis system generates forecasted connectivity by processing the relevant connectivity record(s) using the identified model. As discussed above, in some embodiments, the analysis system processes the records in batches based on the window during which they were received. For example, the analysis system may process records received between 10:00 am and 10:30 am, to predict connectivity for the window from 10:30 am to 11:00 am.

At block 525, the analysis system determines whether one or more alert (or other action) criteria are satisfied. For example, as discussed above, the analysis system may determine whether the actual connectivity for a given window is within some threshold difference of the forecasted connectivity for the given window. If the criteria are not satisfied (e.g., if the actual connectivity is sufficiently similar to the predicted connectivity), the method 500 returns to block 505 to begin processing the next window of data.

If, at block 525, the analysis system determines that the alert criteria are satisfied (e.g., because the actual connectivity and forecasted connectivity differ beyond a threshold), the method 500 continues to block 530, where the analysis system generates one or more alerts, and/or initiates one or more remedial actions, as discussed above. This can allow the analysis system to respond quickly, accurately, and specifically to connectivity issues with high granularity—including potentially identifying the specific region, telecom provider, cell tower, or other equipment that is failing. Similarly, in some embodiments, the analysis system can identify the specific device types or software packages that are causing connectivity issues, enabling rapid troubleshooting and remediation. After the relevant action(s) and alert(s) are generated, the method 500 returns to block 505.

As discussed above, these actions and alerts enable the network(s) to be monitored in real-time (as actual data is received and compared against the predictions). By rapidly identifying technological network issues that prevent connectivity, the analysis system is able to quickly facilitate remediation (e.g., by providing granular and timely alerts to telecom providers or other entities responsible for the faulty link or node).

Additionally, as discussed above, the techniques described herein can be used to prevent faulty analysis or improper actions from being taken by other entities based on the (missing) underlying data. For example, as discussed above, a central application or system may depend on data from the connected devices in order to perform a variety of tasks and analyses. If this flow of data is affected by one or more outages (e.g., such that some subset of the connected devices can no longer transmit updates), the central system can easily make erroneous conclusions or initiate flawed actions, operating on faulty data. Moreover, the partial data can lead to wasted computational resources (e.g., storage, processing time, and energy used to evaluate the partial data). However, as the analysis system enables rapid identification of these connectivity faults, the techniques described herein can prevent or reduce these invalid analyses, wasted computational expenses, and potentially harmful actions from ever being taken. This can significantly improve the technological environment and the functioning of the computing devices and systems themselves.

Example Method for Training a Machine Learning Model Based on Historical Connectivity Data

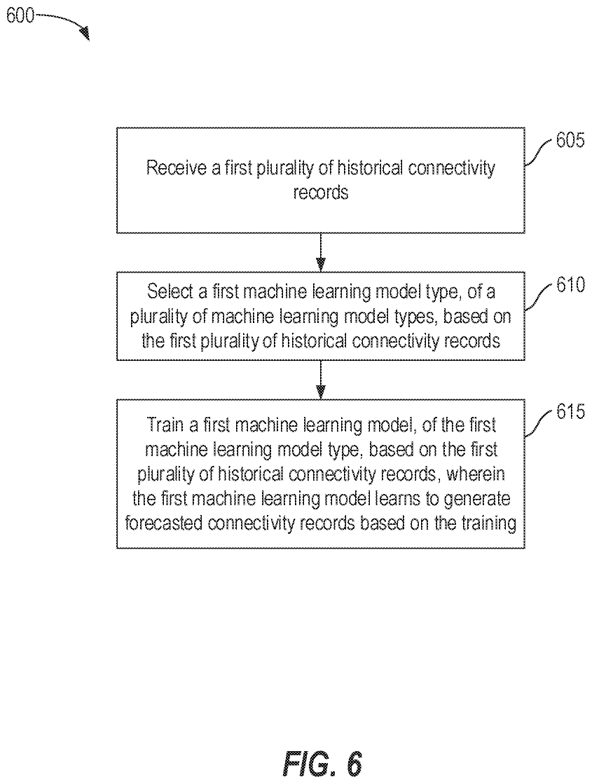

FIG. 6 is a flow diagram depicting an example method 600 of training a machine learning model based on historical connectivity data. In some embodiments, the method 600 is performed by an analysis system (e.g., analysis system 125 of FIG. 1).

At block 605, a first plurality of historical connectivity records is received.

In some embodiments, each of the first plurality of historical connectivity records corresponds to a dial-in from a corresponding device and indicates at least one of: a type of the corresponding device, a network technology used for the dial-in, a geographical region of the corresponding device, or a telecom provider of the corresponding device. At block 610, a first machine learning model type, of a plurality of machine learning model types, is selected based on the first plurality of historical connectivity records.

In some embodiments, all of the first plurality of historical connectivity records were received on defined workdays, and a second machine learning model is trained for a second plurality of historical connectivity records that were received on defined non-workdays.

In some embodiments, the plurality of machine learning model types comprises at least one of: an autoregressive integrated moving average (ARIMA) model type, a Gaussian unbiased parameter estimator model type, a linear regression model type, or a median estimator model type.

In some embodiments, selecting the first machine learning model type comprises determining a number of records, in the first plurality of historical connectivity records, which were received per day.

At block 615, a first machine learning model, of the first machine learning model type, is trained based on the first plurality of historical connectivity records, wherein the first machine learning model learns to generate forecasted connectivity records based on the training.

In some embodiments, the method 600 further includes re-training the first machine learning model daily, based on historical connectivity records associated with a defined number of previous days.

In some embodiments, the method 600 further includes: determining that data, from the first plurality of historical connectivity records, that is associated with a first day is outlier data, removing the outlier data from the first plurality of historical connectivity records, and adding data associated with a second day to the first plurality of historical connectivity records prior to training the first machine learning model.

Example Method for Generating Forecasted Connectivity using a Machine Learning Model

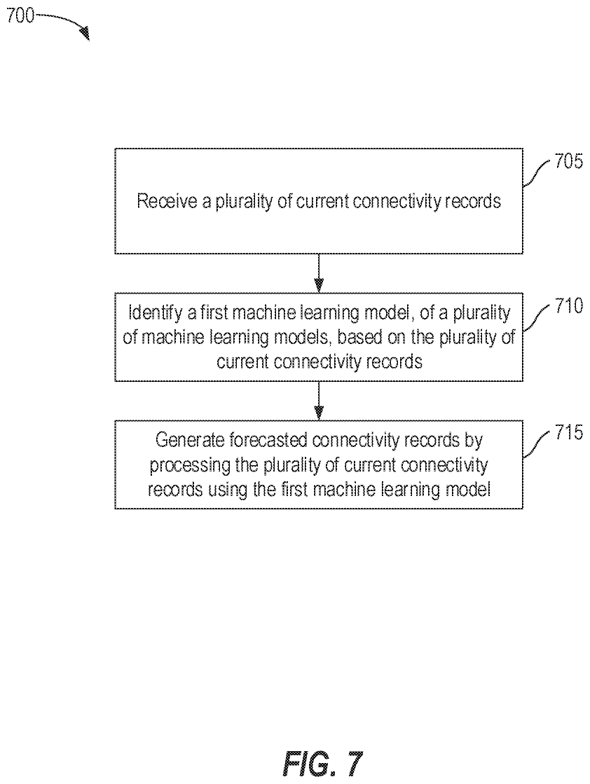

FIG. 7 is a flow diagram depicting an example method 700 of generating forecasted connectivity using a machine learning model. In some embodiments, the method 700 is performed by an analysis system (e.g., analysis system 125 of FIG. 1).

At block 705, a plurality of current connectivity records is received.

In some embodiments, each of the plurality of current connectivity records corresponds to a dial-in from a corresponding device and indicates connection characteristics comprising at least one of: a type of the corresponding device, a network technology used for the dial-in, a geographical region of the corresponding device, or a telecom provider of the corresponding device.

At block 710, a first machine learning model, of a plurality of machine learning models, is identified based on the plurality of current connectivity records.

In some embodiments, the first machine learning model is identified based on the connection characteristics.

In some embodiments, the plurality of current connectivity records were received on a defined workday, the first machine learning model was trained using a first plurality of historical connectivity records that were received on defined workdays, and the plurality of machine learning models comprises at least a second machine learning model that was trained using a second plurality of historical connectivity records that were received on defined non-workdays.

In some embodiments, the plurality of machine learning models comprises at least one of: an autoregressive integrated moving average (ARIMA) model, a Gaussian unbiased parameter estimator model, a linear regression model, or a median estimator model.

At block 715, forecasted connectivity records are generated by processing the plurality of current connectivity records using the first machine learning model.

In some embodiments, the method 700 further includes determining an allowable range for the forecasted connectivity records, and upon determining that the forecasted connectivity records are outside of the allowable range, generating an alert indicating potential connectivity problems.

In some embodiments, the alert indicates at least one of: a type of device associated with the potential connectivity problems, a network technology associated with the potential connectivity problems, a geographical region associated with the potential connectivity problems, or a telecom provider associated with the potential connectivity problems.

In some embodiments, the method 700 further includes identifying one or more entities that receive the plurality of current connectivity records, and transmitting the alert to the one or more entities.

Example Processing System for Machine Learning to Monitor Network Connectivity

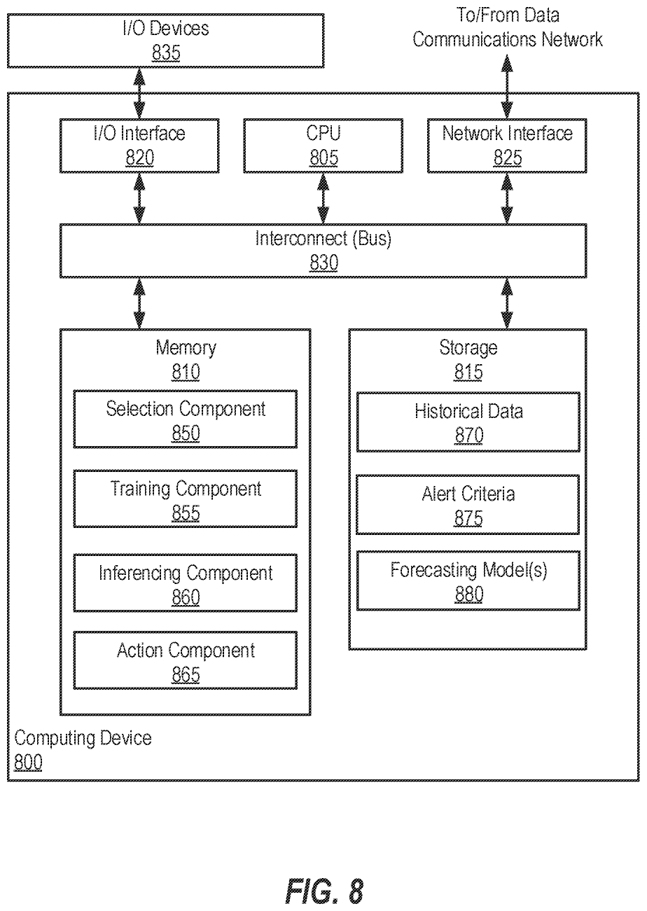

FIG. 8 depicts an example computing device 800 configured to perform various aspects of the present disclosure. Although depicted as a physical device, in embodiments, the computing device 800 may be implemented using virtual device(s), and/or across a number of devices (e.g., in a cloud environment). In one embodiment, the computing device 800 corresponds to the analysis system 125 of FIG. 1.

As illustrated, the computing device 800 includes a CPU 805, memory 810, storage 815, a network interface 825, and one or more I/O interfaces 820. In the illustrated embodiment, the CPU 805 retrieves and executes programming instructions stored in memory 810, as well as stores and retrieves application data residing in storage 815. The CPU 805 is generally representative of a single CPU and/or GPU, multiple CPUs and/or GPUs, a single CPU and/or GPU having multiple processing cores, and the like. The memory 810 is generally included to be representative of a random access memory. Storage 815 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 835 (such as keyboards, monitors, etc.) are connected via the I/O interface(s) 820. Further, via the network interface 825, the computing device 800 can be communicatively coupled with one or more other devices and components (e.g., via a network, which may include the Internet, local network(s), and the like). As illustrated, the CPU 805, memory 810, storage 815, network interface(s) 825, and I/O interface(s) 820 are communicatively coupled by one or more buses 830.

In the illustrated embodiment, the memory 810 includes a selection component 850, a training component 855, an inferencing component 860, and an action component 865, which may perform one or more embodiments discussed above. Although depicted as discrete components for conceptual clarity, in embodiments, the operations of the depicted components (and others not illustrated) may be combined or distributed across any number of components. Further, although depicted as software residing in memory 810, in embodiments, the operations of the depicted components (and others not illustrated) may be implemented using hardware, software, or a combination of hardware and software. In one embodiment, the selection component 850 corresponds to the selection component 210 of FIGS. 2 and 3, the training component 855 corresponds to training component 220 of FIG. 2, inferencing component 860 corresponds to inferencing component 310 of FIG. 3, and/or the action component 865 corresponds to the action component 315 of FIG. 3.

In some embodiments, the selection component 850 may generally be used to select connection records associated with specified sets of characteristics, select a relevant model architecture, and/or select a trained model for the relevant connection characteristics. The training component 855 is generally configured to train machine learning model(s) having indicated model architectures based on historical connectivity records. The inferencing component 860 may be configured to generate predicted or forecasted future connectivity using trained models and current records, as discussed above. The action component 865 may generally be used to identify potential connectivity issues (e.g., based on a mismatch between the actual records and the predicted records), and initiate or trigger various remedial actions, as discussed above.

In the illustrated example, the storage 815 includes historical data 870 (which may correspond to historical connectivity data 205 of FIG. 2), alert criteria 875, and forecasting model(s) 880 (which may correspond to forecasting models 225 of FIGS. 2 and 3). Although depicted as residing in storage 815, the historical data 870, alert criteria 875, and forecasting model(s) 880 may be stored in any suitable location, including memory 810. Generally, the historical data 870 includes the previously-received connectivity (e.g., from one or more prior days) used to train the forecasting models 880. The alert criteria 875 can generally indicate the thresholds or other rules used to determine whether one or more actions should be taken, based on how much the actual connectivity differs from the predicted connectivity.

### EXAMPLE CLAUSES

Implementation examples are described in the following numbered clauses:

Clause 1: A method, comprising: receiving a first plurality of historical connectivity records; selecting a first machine learning model type, of a plurality of machine learning model types, based on the first plurality of historical connectivity records; and training a first machine learning model, of the first machine learning model type, based on the first plurality of historical connectivity records, wherein the first machine learning model learns to generate forecasted connectivity records based on the training.

Clause 2: The method of Clause 1, wherein: all of the first plurality of historical connectivity records were received on defined workdays, and a second machine learning model is trained for a second plurality of historical connectivity records that were received on defined non-workdays.

Clause 3: The method of any one of Clauses 1-2, wherein the plurality of machine learning model types comprises at least one of: an autoregressive integrated moving average (ARIMA) model type, a Gaussian unbiased parameter estimator model type, a linear regression model type, or a median estimator model type.

Clause 4: The method of any one of Clauses 1-3, wherein each of the first plurality of historical connectivity records corresponds to a dial-in from a corresponding device and indicates at least one of: a type of the corresponding device, a network technology used for the dial-in, a geographical region of the corresponding device, or a telecom provider of the corresponding device.

Clause 5: The method of any one of Clauses 1-4, wherein selecting the first machine learning model type comprises determining a number of records, in the first plurality of historical connectivity records, that were received per day.

Clause 6: The method of any one of Clauses 1-5, further comprising re-training the first machine learning model daily, based on historical connectivity records associated with a defined number of previous days.

Clause 7: The method of any one of Clauses 1-6, further comprising: determining that data, from the first plurality of historical connectivity records, that is associated with a first day is outlier data; removing the outlier data from the first plurality of historical connectivity records; and adding data associated with a second day to the first plurality of historical connectivity records prior to training the first machine learning model.

Clause 8: A method, comprising: receiving a plurality of current connectivity records; identifying a first machine learning model, of a plurality of machine learning models, based on the plurality of current connectivity records; and generating forecasted connectivity records by processing the plurality of current connectivity records using the first machine learning model.

Clause 9: The method of Clause 8, further comprising: determining an allowable range for the forecasted connectivity records; and upon determining that the forecasted connectivity records are outside of the allowable range, generating an alert indicating potential connectivity problems.

Clause 10: The method of any one of Clauses 8-9, wherein the alert indicates at least one of: a type of device associated with the potential connectivity problems: a network technology associated with the potential connectivity problems, a geographical region associated with the potential connectivity problems, or a telecom provider associated with the potential connectivity problems.

Clause 11: The method of any one of Clauses 8-10, further comprising: identifying one or more entities that receive the plurality of current connectivity records, and transmitting the alert to the one or more entities.

Clause 12: The method of any one of Clauses 8-11, wherein: the plurality of current connectivity records were received on a defined workday, and the first machine learning model was trained using a first plurality of historical connectivity records that were received on defined workdays, and the plurality of machine learning models comprises at least a second machine learning model that was trained using a second plurality of historical connectivity records that were received on defined non-workdays.

Clause 13: The method of any one of Clauses 8-12, wherein the plurality of machine learning models comprises at least one of: an autoregressive integrated moving average (ARIMA) model, a Gaussian unbiased parameter estimator model, a linear regression model, or a median estimator model.

Clause 14: The method of any one of Clauses 8-13, wherein each of the plurality of current connectivity records corresponds to a dial-in from a corresponding device and indicates connection characteristics comprising at least one of: a type of the corresponding device, a network technology used for the dial-in, a geographical region of the corresponding device, or a telecom provider of the corresponding device.

Clause 15: The method of any one of Clauses 8-14, wherein the first machine learning model is identified based on the connection characteristics.

Clause 16: A system, comprising: a memory comprising computer-executable instructions; and one or more processors configured to execute the computer-executable instructions and cause the processing system to perform a method in accordance with any one of Clauses 1-15.

Clause 17: A system, comprising means for performing a method in accordance with any one of Clauses 1-15.

Clause 18: A non-transitory computer-readable medium comprising computer-executable instructions that, when executed by one or more processors of a processing system, cause the processing system to perform a method in accordance with any one of Clauses 1-15.

Clause 19: A computer program product embodied on a computer-readable storage medium comprising code for performing a method in accordance with any one of Clauses 1-15.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., elopement analyzer 205) or related data available in the cloud. For example, the elopement analyzer 205 could execute on a computing system in the cloud and generate elopement likelihoods. In such a case, the elopement analyzer 205 could generate scores and selectively enable or disable sensors, and store the models, sensor data, and/or extrinsic data at a storage location in the cloud. Doing so allows a user to access this information from any computing system attached to a network connected to the cloud (e.g., the Internet).

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of training a machine learning model to predict device connectivity, comprising:
receiving a first plurality of historical connectivity records;
selecting a first machine learning model type, of a plurality of machine learning model types, based on the first plurality of historical connectivity records; and
training a first machine learning model, of the first machine learning model type, based on the first plurality of historical connectivity records, wherein the first machine learning model learns to generate forecasted connectivity records based on the training.

2. The method of claim 1, wherein:
all of the first plurality of historical connectivity records were received on defined workdays, and
a second machine learning model is trained for a second plurality of historical connectivity records that were received on defined non-workdays.

3. The method of claim 1, wherein the plurality of machine learning model types comprises at least one of:
an autoregressive integrated moving average (ARIMA) model type,
a Gaussian unbiased parameter estimator model type,
a linear regression model type, or
a median estimator model type.

4. The method of claim 1, wherein each of the first plurality of historical connectivity records corresponds to a dial-in from a corresponding device and indicates at least one of:
a type of the corresponding device,
a network technology used for the dial-in,
a geographical region of the corresponding device, or
a telecom provider of the corresponding device.

5. The method of claim 1, wherein selecting the first machine learning model type comprises determining a number of records, in the first plurality of historical connectivity records, that were received per day.

6. The method of claim 1, further comprising re-training the first machine learning model daily, based on historical connectivity records associated with a defined number of previous days.

7. The method of claim 1, further comprising:
determining that data, from the first plurality of historical connectivity records, that is associated with a first day is outlier data;
removing the outlier data from the first plurality of historical connectivity records; and
adding data associated with a second day to the first plurality of historical connectivity records prior to training the first machine learning model.

8. A method of predicting device connectivity using machine learning, comprising:
receiving a plurality of current connectivity records;
identifying a first machine learning model, of a plurality of machine learning models, based on the plurality of current connectivity records; and
generating forecasted connectivity records by processing the plurality of current connectivity records using the first machine learning model.

9. The method of claim 8, further comprising:
determining an allowable range for the forecasted connectivity records; and
upon determining that the forecasted connectivity records are outside of the allowable range, generating an alert indicating potential connectivity problems.

10. The method of claim 9, wherein the alert indicates at least one of:
a type of device associated with the potential connectivity problems,
a network technology associated with the potential connectivity problems,
a geographical region associated with the potential connectivity problems, or
a telecom provider associated with the potential connectivity problems.

11. The method of claim 9, further comprising:
identifying one or more entities that receive the plurality of current connectivity records, and
transmitting the alert to the one or more entities.

12. The method of claim 8, wherein:
the plurality of current connectivity records were received on a defined workday,
the first machine learning model was trained using a first plurality of historical connectivity records that were received on defined workdays, and
the plurality of machine learning models comprises at least a second machine learning model that was trained using a second plurality of historical connectivity records that were received on defined non-workdays.

13. The method of claim 8, wherein the plurality of machine learning models comprises at least one of:
an autoregressive integrated moving average (ARIMA) model,
a Gaussian unbiased parameter estimator model,
a linear regression model, or
a median estimator model.

14. The method of claim 8, wherein each of the plurality of current connectivity records corresponds to a dial-in from a corresponding device and indicates connection characteristics comprising at least one of:
a type of the corresponding device,
a network technology used for the dial-in,
a geographical region of the corresponding device, or
a telecom provider of the corresponding device.

15. The method of claim 14, wherein the first machine learning model is identified based on the connection characteristics.

16. A system, comprising:
a memory comprising computer-executable instructions; and
one or more processors configured to execute the computer-executable instructions and cause the system to perform an operation comprising:
receiving a first plurality of historical connectivity records;
selecting a first machine learning model type, of a plurality of machine learning model types, based on the first plurality of historical connectivity records; and
training a first machine learning model, of the first machine learning model type, based on the first plurality of historical connectivity records, wherein the first machine learning model learns to generate forecasted connectivity records based on the training.

17. The system of claim 16, wherein selecting the first machine learning model type comprises determining a number of records, in the first plurality of historical connectivity records, that were received per day.

18. The system of claim 16, the operation further comprising re-training the first machine learning model daily, based on historical connectivity records associated with a defined number of previous days.

19. A system, comprising:
a memory comprising computer-executable instructions; and
one or more processors configured to execute the computer-executable instructions and cause the system to perform an operation comprising:
receiving a plurality of current connectivity records;
identifying a first machine learning model, of a plurality of machine learning models, based on the plurality of current connectivity records; and
generating forecasted connectivity records by processing the plurality of current connectivity records using the first machine learning model.

20. The system of claim 19, the operation further comprising:
determining an allowable range for the forecasted connectivity records; and
upon determining that the forecasted connectivity records are outside of the allowable range, generating an alert indicating potential connectivity problems.
